(19) United States
(12) Patent Application Publication
(10) Pub. No.: US 2006/0094411 A1
(43) Pub. Date: May 4, 2006

(54) Mobile station telephony service applications for mobile station having integrated transponder readers

(76) Inventor: Pierre B. Dupont, Slocan (CA)

Correspondence Address: MOTOROLA INC, 600 NORTH US HIGHWAY 45, ROOM AS437, LIBERTYVILLE, IL, 60048-5343, US

(21) Appl. No.: 10/976,563

(22) Filed: Oct. 29, 2004

(51) Int. Cl. H04M 3/42

(52) U.S. Cl. 455/417

(57) ABSTRACT

In an embodiment of the present invention, a mobile station (301) interrogates an RFID tag (305) which may be located on a desk top phone (303), or an advertising billboard, and receives data. The mobile station (301) parses the data to obtain a telephone number, which may be an IP address for VoIP devices. Another portion of the data is interpreted to determine a telephony service to be initiated by the mobile station. The telephony services may be for example, calling a telephone number advertised by the billboard, forwarding future calls to the mobile device to the desk top phone (303), or setting up a three-way call using the desk top phone (303) as one of the participants.

### FIELD OF THE INVENTION

The present invention relates generally to wireless networks, and more particularly to mobile stations, RFID readers, and to the field of physical browsing.

### BACKGROUND OF THE INVENTION

Communication networks such as GSM and GPRS, WCDMA, EDGE and various wireless local area network (WLAN) technologies such as 802.11 and Bluetooth™ enable Internet connectivity of mobile stations as well as Internet browsing. However, mobile station user interfaces are quite small and make it somewhat cumbersome to enter character commands or a URL text string, which limits a mobile station effectiveness for wireless Internet browsing. Further, the small keyboards prevalent on most mobile stations render launching applications using typed commands equally difficult.

Various advertising billboards, posters or other displays may provide URL text strings or other information that a mobile station user may want to access. If the information is a URL or telephone number, the user would of course have to manually enter this information into the mobile station user interface in order to access the data. Depending on the location of the displayed information or the current activity of the user, it may be inconvenient or even impossible to enter the information into the mobile station.

Other situations exist in which data entry may not be problematic, but seamless operation and interaction could be better utilized and improved. Additionally, advertisers would benefit if users could access the information provided by advertising displays in a more convenient, or rather a more seamless manner. Every user that accesses such information is a potential customer and therefore a potential source of revenue. Likewise, carriers and service providers may benefit from business relationships where mobile station users are more easily connected-with by advertisers.

Radio Frequency Identification (RFID) systems use radio technology to remotely read data from a transponder, known as an RF tag or simply a tag. An RFID system generally comprises an RFID reader, a reader antenna, and a tag which also comprises a tag antenna. An RFID reader is sometimes combined with a decoder and is referred to as an interrogator.

RFID systems are generally of two types, inductively coupled and propagation coupled. An inductively coupled system requires that the tag come within a close proximity of the RFID reader. Propagation coupled systems allow reading of tags from greater distances by transmitting radio waves from the reader and receiving a signal back from a tag. Additionally, tags may be active or passive, which is a factor in the size and weight of the tag. Passive tags can be extremely small in size and weight and are therefore ideal for certain applications such as theft detection in retail stores, because such tags can be easily concealed within a product's packaging and detected by a receiving antenna positioned near a store exit.

RFID systems have therefore become widespread because of their usefulness for information collection and tracking and many applications have emerged. For example, livestock may be labeled and tracked by tags for the purpose of preventing diseased animals, or groups of animals, from entering into food production. In addition to theft prevention, retail stores may tag items for the purpose of performing quick inventory by simply scanning the shelved or warehoused items.

If the beneficial aspects of RFID data collection systems could be made use of for mobile station communication, the problems associated with data collection, particularly data useful for accessing or launching applications on a mobile device, may be eliminated.

More particularly, various mobile telephony services could be made such that more seamless operation could be realized. Therefore a need exists for an apparatus and method which combines the telephonic service capabilities of a mobile station with the data access capabilities of an RFID system. The apparatus and method would improve the use-ability of mobile stations for telephony services, and would ideally integrate RFID capabilities with mobile station technology such that a mobile station may benefit from publicly available RFID accessible data.

### BRIEF DESCRIPTION OF THE DRAWINGS

FIG. 1 is a block diagram illustrating a network infrastructure in which a mobile station may operate in accordance with embodiments of the present invention.

FIG. 2 is a block diagram illustrating the primary components of a mobile station in accordance with some embodiments of the present invention.

FIG. 3 is a block diagram illustrating an apparatus and method for call-forwarding in accordance with an embodiment of the present invention.

FIG. 4 is a block diagram illustrating an apparatus and method for paying a parking fee in accordance with an embodiment of the present invention.

FIG. 5 is a block diagram illustrating an exemplary basic menu format of some embodiments of the present invention.

FIG. 6 is a block diagram illustrating an exemplary menu for embodiments of the present invention in which an RFID tag represents a number of selectable services.

FIG. 7 is a block diagram illustrating an embodiment of the present invention in which an RFID service kiosk is located at, and designated as, a bus stop.

FIG. 8 is a block diagram of RFID tag information bit fields in accordance with some embodiments of the present invention.

FIG. 9 is a flow diagram illustrating the basic operation of embodiments of the present invention that use RFID tag information to access a server.

FIG. 10 is a flow diagram illustrating the basic operation of embodiments of the present invention in which RFID tag information is used to invoke action by the mobile station or to invoke the mobile station to utilize or activate a network service.

FIG. 11 is a block diagram illustrating a personal alarm system in accordance with an embodiment of the present invention.

### DETAILED DESCRIPTION OF THE PREFERRED EMBODIMENTS

To address the above-mentioned need, a method and apparatus for enabling mobile station telephony services is provided herein.

In accordance with the present invention, a mobile station comprises a transponder interrogator and may receive and decode data from a transponder. The transponder may be physically located on an advertising billboard or on a stationary public telephone.

The transponder data is decoded by the mobile station and a portion is interpreted to determine a telephone number, which may be an IP address for VoIP devices. Another portion of the data is interpreted to determine a telephony service to be initiated by the mobile station. The telephony services may be for example, calling a telephone number advertised by a billboard, forwarding future calls to the mobile device to a stationary phone, or setting up a three-way call using the stationary phone as one of the participants.

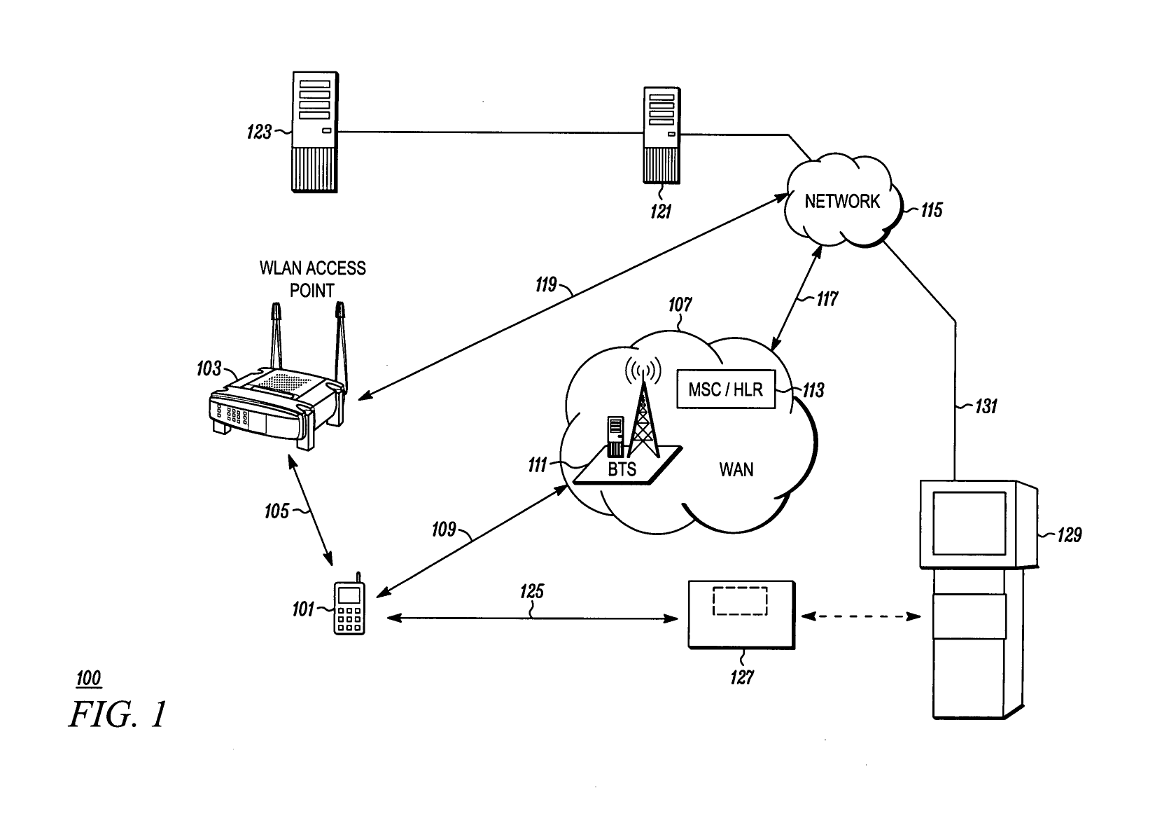

Turning now to the drawings wherein like numerals represent like components, FIG. 1 is a block diagram illustrating a network infrastructure in which a mobile station may operate in accordance with embodiments of the present invention. In FIG. 1, mobile station 101 is capable of communicating with a Wireless Local Area Network (WLAN) via WLAN Access point (AP) 103 and WLAN air interface 105 which may be 802.11, Bluetooth™, IrDA, HomeRF, etc. Mobile station 101 communicates with a cellular network 107 via cellular air interface 109 which may be GSM, CDMA, CDMA2000, UMTS, etc.

The cellular network 107 is a wide area network (WAN) and comprises various components such as Base Transceiver Station (BTS) 111 and Mobile Switching Center (MSC) 113 which also comprises a Home Location Register (HLR).

It is to be understood that the WAN 107 as shown in FIG. 1 is for illustrative purposes only, and that the WAN will comprise a number of BTSs, MSCs, HLRs, as well as other components not specifically mentioned herein.

The WAN 107 may also communicate with other networks such as network 115, which may be the Internet, via connection 117 which may make use of any suitable connection means. Similarly, the WLAN network, or AP 103 may communicate with network 115 via connection 119, which may make use of any suitable connection means including, but not limited to; a leased telephone line, T1, E1, infra-red, or a radio frequency point-to-point connection. The network 115 may comprise a number of smaller networks or servers such as RFID server 121 and application server 123.

The mobile station 101 comprises an RFID component which can transmit and receive signals over an air interface 125, to read data from an RFID tag 127. After reading the information provided by tag 127, the mobile station 101 may use the information to access RFID server 121 or application server 123 via the WLAN AP 103 or WAN 107.

Also illustrated in FIG. 1 is RFID service kiosk 129, which may have a network connection 131, such that the RFID service kiosk 129 may transmit and receive information to and from one or both of RFID server 121 and application server 123. The RFID service kiosk 129 will usually have a visible indicator to show mobile station users the type of RFID service accessible from the kiosk. The kiosk will also have RFID tag 127 located on or within it such that mobile station 101 may interrogate and receive information from the tag via air interface 125.

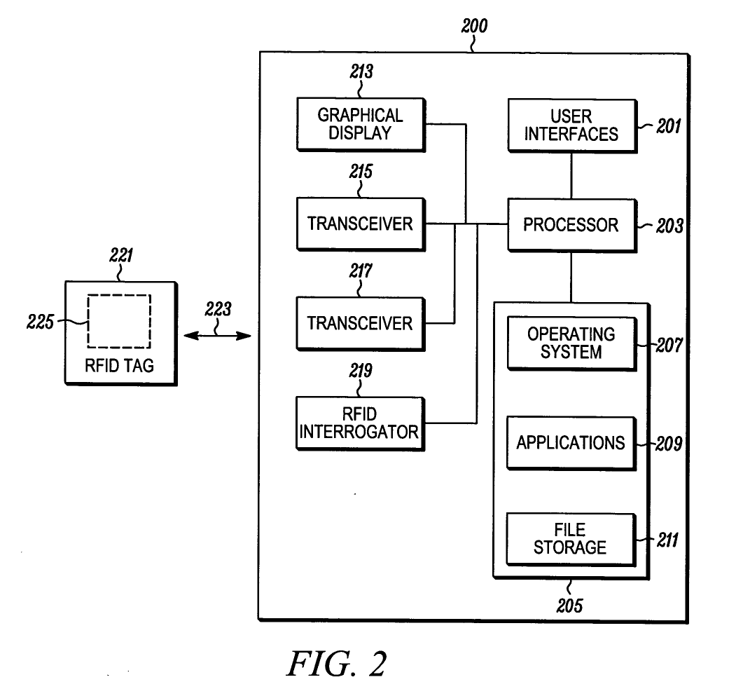

FIG. 2 is a block diagram illustrating the primary components of a mobile station in accordance with some embodiments of the present invention. Mobile station 200 comprises user interfaces 201, at least one processor 203, and a memory 205. Memory 205 has storage sufficient for the mobile station operating system 207, applications 209 and general file storage 211. Mobile station 200 user interfaces 201, may be a combination of user interfaces including but not limited to a keypad, touch screen, voice activated command input, and gyroscopic cursor controls.

Mobile station 200 has a graphical display 213, which may also have a dedicated processor and/or memory, drivers etc. which are not shown in FIG. 2. It is to be understood that FIG. 2 is for illustrative purposes only and is for illustrating the main components of a mobile station in accordance with the present invention, and is not intended to be a complete schematic diagram of the various components required for a mobile station. Therefore, a mobile station may comprise various other components not shown in FIG. 2 and still be within the scope of the present invention.

Returning to FIG. 2, the mobile station 200 also comprises a number of transceivers such as transceivers 215 and 217. Transceivers 215 and 217 may be for communicating with various wireless networks such as WLAN AP 103 and WAN 107 using for example 802.11 and GSM, respectively.

In addition to the transceivers 215 and 217, mobile station 200 comprises an additional wireless capability, specifically RFID interrogator 219, for communicating with RFID tag 221 using air interface 223. The RFID tag 221 comprises and internal antenna 225, and the RFID interrogator 219 likewise has an internal antenna although this antenna is not explicitly illustrated in FIG. 2. A user may activate the mobile station 200 RFID interrogator 219 by activating, for example, a button which is part of the user interfaces 201. Any suitable user activation of RFID interrogator 219 may be used and would still remain within the scope of the present invention.

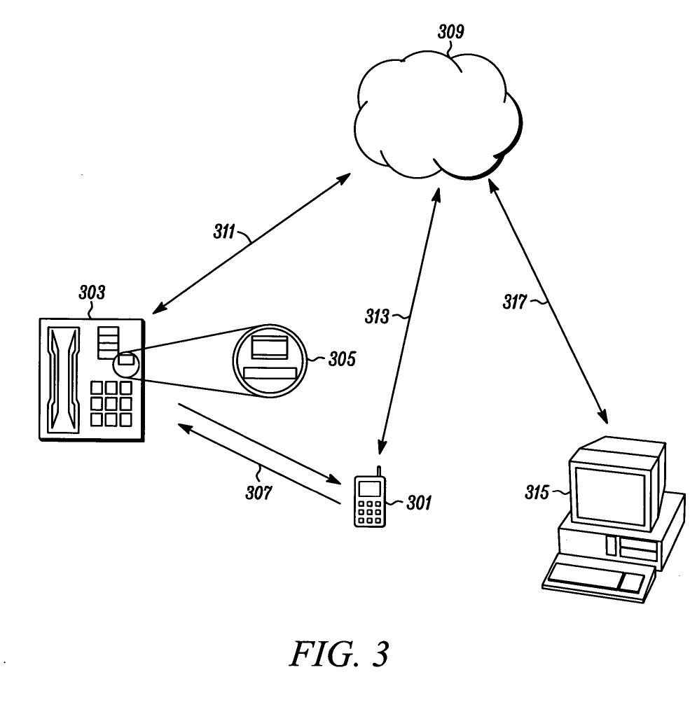

Turning now to FIG. 3, an apparatus and method for call-forwarding in accordance with an embodiment of the present invention is illustrated. In FIG. 3, mobile station 301 comprises the components illustrated by FIG. 2 for mobile station 200, such that mobile station 301 may interrogate and receive information from an RFID tag. A desk top phone 303 comprises an RFID tag 305, which also has a visible indicator, for example a label indicating that the device supports “RFID Push-to-Forward.” A user having a mobile station such as mobile station 301, which comprises the RFID interrogator 219 component may take advantage of external functionalities such as that illustrated by FIG. 3.

The desk top phone 303 may be an Internet Protocol (IP) phone or a standard wire-line (POTS) set, and may be located at a library, an airport, an office cubicle, or any other suitable location having such a phone that is for temporary use. The mobile station 301 user, who wishes to temporarily have calls forwarded to the desk set 303, may activate the RFID interrogator 219, by for example pushing a button on the mobile station 301 user interfaces 201. The mobile station 301 will transmit a suitable radio signal 307 and receive back a signal from the RFID tag 305 which provides identification information for desk set 303 such as its wire-line phone number or IP address.

Important to note is that the desk phone 303 communicates with a network 309 via connection 311. Network 309 may be for example the Public Switched Telephone Network (PSTN), the Internet, or any other suitable communications network. Mobile station 301 may, via its particular service provider's network for example WAN 107 or WLAN AP 103, likewise communicate with network 309 via a communications path 313. Communications path 313 may comprise several paths through several networks as understood by one of ordinary skill in the art of communications networks.

The mobile station 301, may for example, obtain the desk phone 303 telephone number from RFID tag 305, and subsequently perform automatically a forwarding operation with MSC 113 such that any future calls to mobile station 301 would be forwarded to desk phone 303 through network 309. The mobile station 301 user could proceed to make use of desk phone 303 as its temporary office phone while working nearby in a temporary workspace for example. The user could be billed for the service in a variety of ways, one way being receiving the charge on the user's mobile station service bill.

In a second embodiment of the present invention, the mobile station 301 user may have its calls forwarded to a soft-phone application residing on a workstation 315. The workstation 315 is connected to network 309 via a connection path 317. Similar to the embodiment using desk phone 303, the mobile station 301 interrogates an RFID tag placed on or within workstation 315 and performs an automatic forwarding operation with its MSC 113.

In embodiments where the desk-phone 303 or workstation 315 soft-phone application is an IP-phone, the RFID tag would supply an IP address such that the mobile station 301 would have future calls forwarded to the IP address. It is to be understood that either the WLAN AP 103 or WAN 107, which in FIG. 3 are collectively represented by network 309 as well as any other required intermediary networks, are capable of supporting an IP connection to mobile station 301 such that all calls received and placed by mobile station 301 may voice-over-IP (VoIP) calls, or may be a combination of wireless trunked and wireless VoIP calls.

The above described embodiments are particularly useful for saving battery time of the mobile station 301 when such RFID based services are available, and may also result in less expensive per minute charges than would be billed for wireless minutes. Various business models may be constructed using the embodiments of the present invention as would be easily recognized by one of ordinary skill in the art.

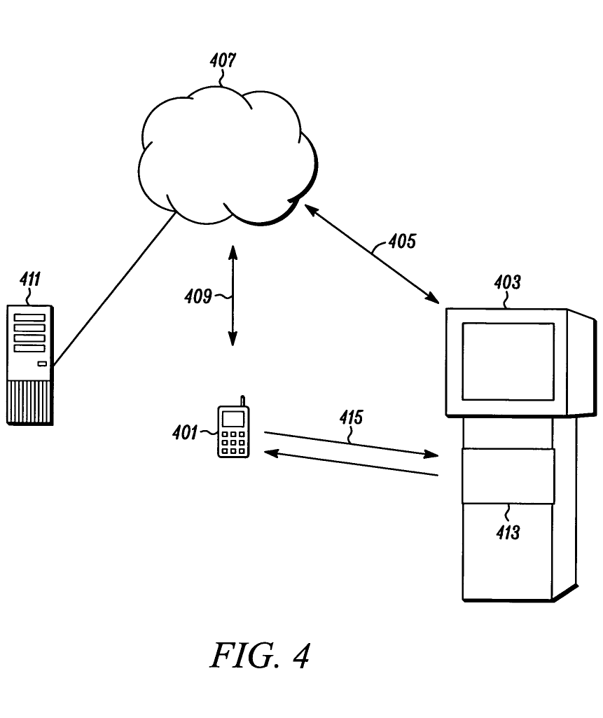

Turning now to FIG. 4, an apparatus and method for paying a parking fee in accordance with an embodiment of the present invention is illustrated. In FIG. 4, mobile station 401 comprises the components illustrated by FIG. 2 for mobile station 200, such that mobile station 401 may interrogate and receive information from an RFID tag. A parking payment kiosk 403 is connected 405 to a network 407 such as the PSTN, the Internet, or any other suitable communications network. Mobile station 401 may, via its particular service provider's network for example WAN 107 or WLAN AP 103, likewise communicate with network 407 via a communications path 409. Communications path 409 may comprise several paths through several networks as understood by one of ordinary skill in the art of communications networks. Mobile station 401, is able to receive information from the server 411 via the communication path 409.

The parking payment kiosk 403 comprises an RFID tag 413, which also has a visible indicator, for example a label indicating that the device supports “RFID Push to Pay.” A user having a mobile station such as mobile station 401, which comprises the RFID interrogator 219 component may take advantage of external functionalities such as that illustrated by FIG. 4.

The parking kiosk 403 is capable of communicating with a transaction server, for example server 411. The transaction server 411 is capable of communicating with the network 407 such that the transaction server may also communicate with mobile station 401 via a mobile station communication path 409. Further, the RFID service may comprise an additional server, or servers, such as RFID server 121 as shown in FIG. 1. The RFID server 121, in some embodiments, receives the RFID tag data obtained by a mobile station and verifies that the mobile station has access to the RFID capability. The RFID server 121 in some embodiments, may proceed to establish communication between the mobile station, kiosk and transaction server acting as a temporary intermediary. Alternatively, the verification of service access may be performed by the transaction server 411 independently.

Returning now to FIG. 4, the mobile station 401 user, upon exiting the parking facility, or at the entrance of the parking facility just prior to retrieving the user's car, the user may be able to access the “RFID Push-to-Pay” service kiosk 403. The user may activate the mobile station 401 RFID interrogator component 219 by the user interfaces 201 and, for example, pushing a button. The mobile station 401 RFID interrogator 219 will query the kiosk's RFID tag 413, via air interface 415, and retrieve data which it subsequently transmits to the network via communications path 409.

The data extracted from the RFID tag 413 contains data necessary for accessing the transaction server 411, and may contain a Uniform Resource Locator (URL) as well as other information required for processing and routing of the information by the mobile station 401 service provider. Additional information contained in the data may include, but not be limited to; application type, initial instructions, destination address, and tag location. The application type may include for example; voice call services, short-message-service (SMS), Java download, XML etc. Examples of instructions that might be contained in the data include “display tag info,” “go to URL,” “initiate voice call,” “join group call,” “set call forward,” “send SMS,” “send email,” “send IM,” “download video,” “play streaming audio,” etc. Destination address information may include; a Web URL, telephone number, IP address, SMS address, etc. Location information may include; GPS coordinates, a street address, a site identifier such as a postal zip code or airport code, a neighborhood or municipality name, etc. Returning now to FIG. 4, the network 407 may subsequently establish a communication between transaction server 411 and mobile station 401.

The transaction server 411 may execute an application, or alternatively may download an applet to mobile station 401, which may be executed by the mobile station 401 operating system 205, or operate as an embedded applet of an existing mobile station application 207 such as a Web or Wireless Application Protocol (WAP) browser.

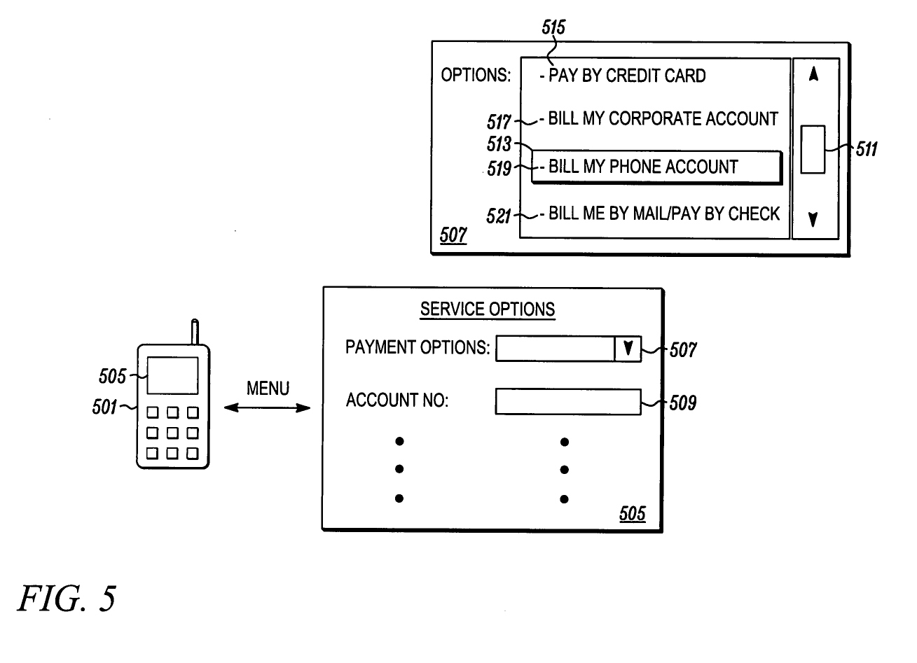

FIG. 5 illustrates a basic menu format of some embodiments of the present invention. The transaction server, such as transaction server 411, may download an applet to a mobile station 501 which displays a service options menu 505 to the user. The service options menu may for example comprise a number of sub-menus such as payment options 507, and an account number field 509. For example, payment options sub-menu 507 may, upon user selection, display a scroll bar 511 and a selection cursor 513, and provide further details of the payment options such as; “pay by credit card” 515, “bill my corporate account” 517, “bill my phone account” 519, and “bill me by mail/pay by check” 521.

It is to be understood that the menu illustrated by FIG. 5 is for exemplary purposes only and that many possible menu configurations are conceivable, and that any such conceivable menu configurations would remain within the scope of the various embodiments of the present invention.

Returning now to FIG. 4, the user of mobile station 401 may select a payment option, for example by making a menu selection from service options menus 505. The mobile station 401 will then transmit the user's selection, including any other required input information such as a credit card number, via the communication path 409 to the transaction server 411. The transaction server 411 will process the payment, and if the payment is successfully completed, will instruct the parking payment kiosk 403, via network 407, to print out a paper payment receipt that the user may take. The payment receipt may, in some embodiments, be a paper magnetic strip card that the user must input into a reader at the parking facility exit gate, in order to open the gate and exit. Alternatively, the kiosk may produce a separate receipt and paper magnetic strip card.

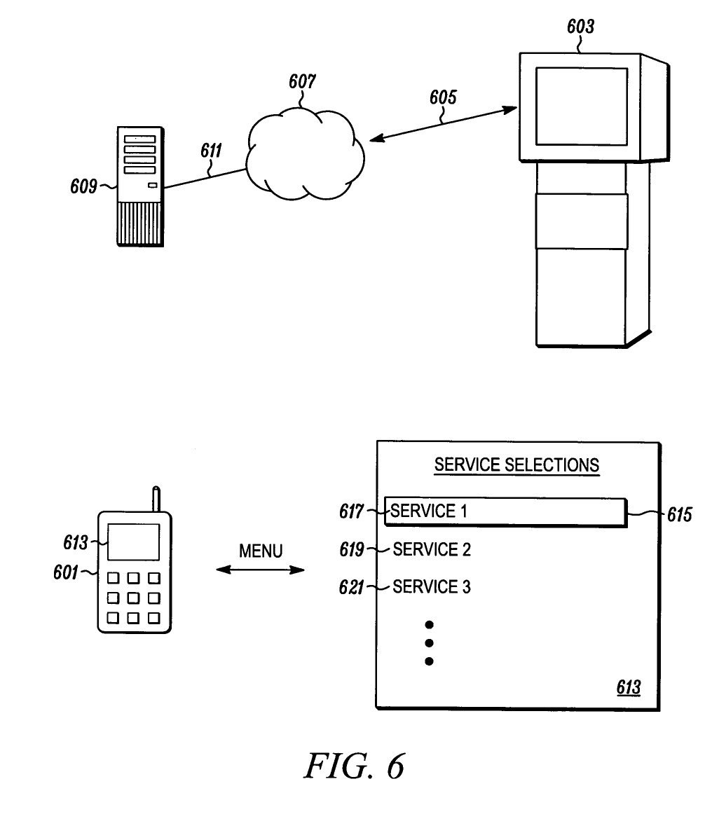

FIG. 6 illustrates an exemplary menu for embodiments in which an RFID tag represents a number of selectable services. In FIG. 6, mobile station 601 comprises the components illustrated by FIG. 2 for mobile station 200, such that mobile station 601 may interrogate and receive information from an RFID tag. FIG. 6 also illustrates an exemplary system architecture in which an RFID service kiosk 603 has a network connection 605 to a network 607, which may be the Internet, and communicates with an RFID application server 609. The RFID application server 609 communicates with the network 607 via network connection 611.

The RFID service kiosk 603 may be located at any convenient location, indoors or outdoors, where a user may access the service using a mobile station 601 which comprises an RFID interrogator 219. The mobile station 601 may interrogate an RFID tag of RFID service kiosk 603. The mobile station 601 may then use the RFID tag information to access, through a service provider of mobile station 601, the RFID application server 609 using any suitable protocol and any suitable wireless interface of which mobile station 601 is capable.

The RFID application server 609 may in some embodiments, transmit an applet to mobile station 601 and cause the mobile station 601 to display service selections menu 613 to the user. The service selections menu 613 may further comprise a selection cursor 615 and allow the user to select from a number of services, for example; service 1 617, service 2 619, and service 3 621, etc. Other applets or applications may be subsequently downloaded and launched by RFID application server 609, or launched from applications 207 stored in memory, in response to user service selection from service selection menu 613. One of the embodiments of such a kiosk service may be the parking payment kiosk previously described. In this case however, the kiosk would be capable of providing other services in addition to merely providing payment options for parking. For example, the RFID service kiosk 603 may, in addition to providing payment options for parking, provide the user with a downloadable listing of local restaurants near the parking facility.

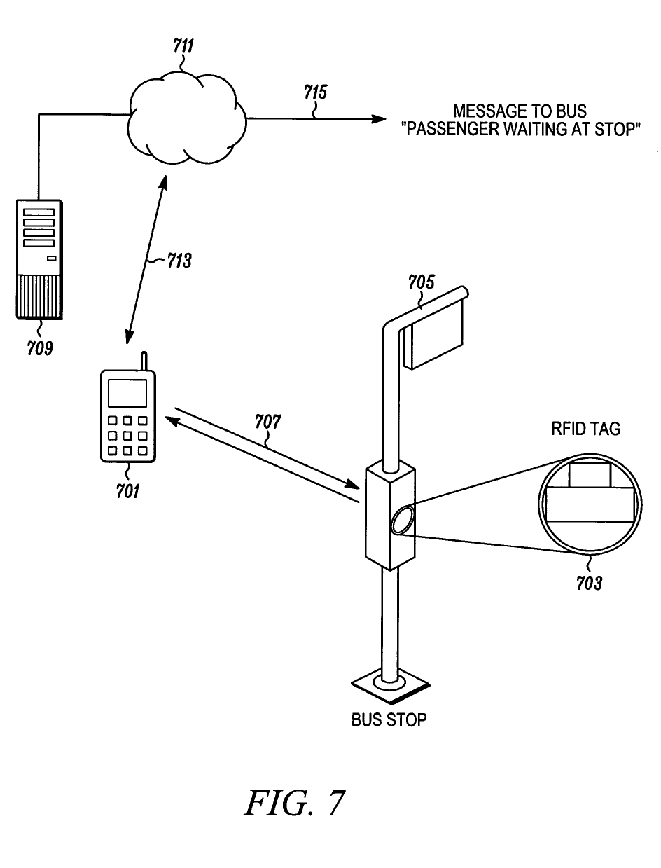

It is to be understood that many possible services and combinations of services may be conceivable, and that any such conceivable services provided by an RFID service kiosk as described herein would remain within the scope of the various embodiments of the present invention. For example, FIG. 7 illustrates another embodiment in which an RFID service kiosk is used at a bus stop.

In FIG. 7, the mobile station 701 user may activate the mobile station RFID interrogator 219 to interrogate RFID tag 703 of bus stop 705 using air interface 707, access the bus schedule and also notify the driver of the particular route that the user is waiting. For the schedule information the RFID tag 703 may contain sufficient information to provide the mobile station 701 with the schedule directly.

However, the RFID tag 703 may contain access information such that mobile station 701 may access server 709 via network 711 and mobile station communication path 713. In this case the mobile station 701 may use the server to download the bus schedule.

For driver notification, the server may transmit to network 711 a “passenger waiting at stop” message 715 which may further indicate a stop number or street. The stop number or street is known from the RFID tag 703 information, which mobile station 701 transmits to the server 709 during access procedures. If the bus has a wireless network connection of any suitable type, for example an WLAN 802.11 capability, the bus may receive the “passenger waiting at stop” message 715 from an appropriate transmitter as understood by one of ordinary skill in the art.

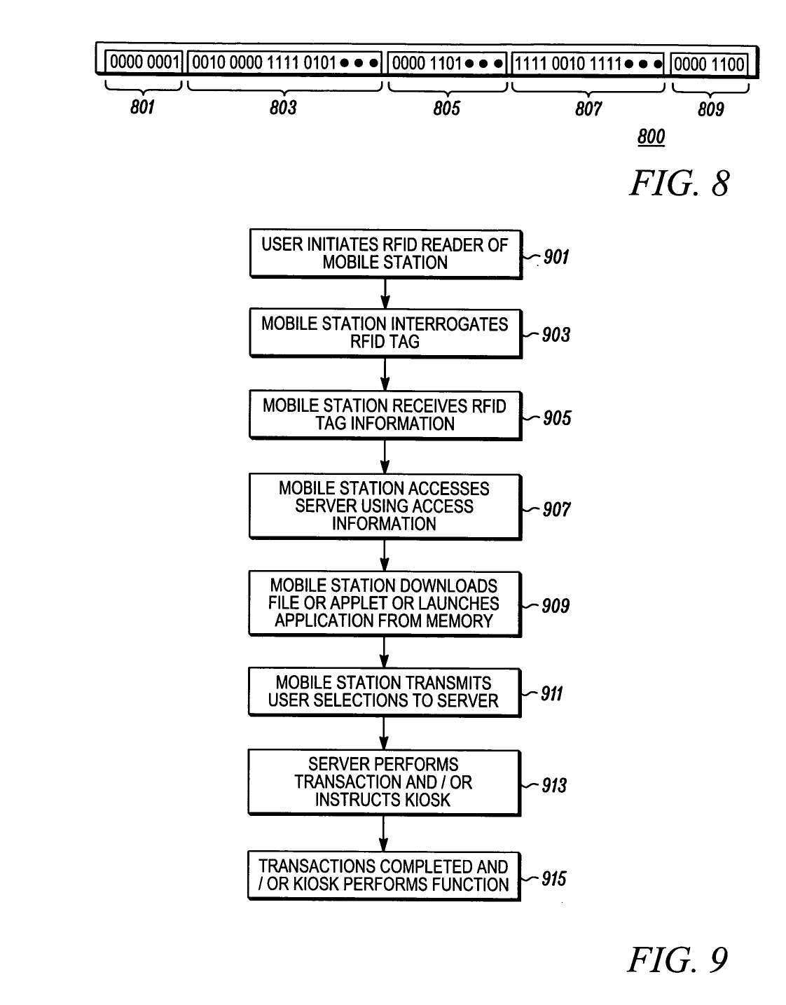

FIG. 8 illustrates further details of RFID tag information in accordance with some embodiments of the present invention. In FIG. 8, the RFID tag information 800 is represented as a series of bit fields. The bit fields in some embodiments may conform to standards applicable to an Electronic Product Code (EPC). For example, a first bit field 801 may be a header or flag and contain 8 bits. The second bit field 803 may conform to the EPC manager field and contain 28 bits. The third bit field 805 may be designated as an object class field and contain 24 bits. The fourth bit field 807 may be a serial number field and contain 36 bits. Additionally, an optional bit field 809 may provide a check digit, which may be 8 bits in length, for the purpose of verification of the RFID tag information transfer. For example, the bit fields 801, 803, 805, and 807 may when input into a checking algorithm produce the check digit provided by bit field 809. The checking algorithm may be executed by mobile station processor 203 as a mobile station application 209 stored in mobile station memory 205.

It is to be understood that the bit fields illustrated by FIG. 8 are exemplary only and that any segregation of bit fields is possible and that any such bit segregations would remain in accordance with the embodiments of the present invention. Further, the embodiments of the present invention may use various overall bit lengths such as, but not limited to 96 bits, 256 bits, 512 bits or greater and that the segregation of bit fields may be made in any manner appropriate for a particular application and would remain in accordance with the embodiments of the present invention. Further, although certain RFID tag bit length storage may be standardized by the RFID tag industry, bit lengths of less than 96 bits, in which a 96 bit length is generally made use of by Electronic Product Codes (EPCs) for example, may be used and remain in accordance with the embodiments of the present invention.

In some embodiments of the present invention, various bit fields of RFID tag information 800 may be used in various ways. For example, the first bit field 801 may indicate to the mobile station that the remaining information, in subsequent bit fields, will contain a telephone number. In that case, a “RFID Push-to-Call” application or applet residing in mobile station applications 209 would be invoked by processor 203, and may receive, for example a set of DTMF digits contained in any subsequent field or combination of fields of RFID tag information 800.

For example, a telephone number for a taxi service “800-555-1234” may be represented by a number of bits, for example 80 bits, with 8 bits per base ten digit, using a combination of the various bit fields of RFID tag information 800. Other bit representations may be used in other embodiments employing digit representations based on text compression techniques such that much less than 80 bits would be required to represent a telephone number, IP address, or other appropriate information. In that case, the mobile station applications 209 would comprise the appropriate algorithms for interpreting the compressed text representations, and may make use of the information based on the indication of the first bit field 801.

In the embodiments of the present invention, the RFID tag 800 first bit field 801 may be categorized into various mobile station interpretations including, but not limited to; “connect to remote server,” “dial digits,” “IP connection,” “launch application type,” etc., such that a mobile station will take action, or invoke a network action, based upon the specific interpretation. Further, the bit field 801 interpretation may determine how the mobile station utilized the bit field data of the remaining bit fields of RFID tag information 800.

FIG. 9 is a flow diagram illustrating the basic operation of some embodiments of the present invention, making use of RFID tag information 800. In block 901, a user may initiate the RFID interrogator 219 when an RFID tag is present for providing an RFID service, for example an “RFID Push-to-X” service, including but not limited to “Push-to-Call,” “Push-to-Pay,” “Push-to-Ride,” “Push-to-View,” “Push-to-Listen,” etc.

In block 903, the mobile station interrogates the RFID tag and in block 905 receives the RFID tag information 800, including a first bit field 801. In block 907, the mobile station interprets the first bit field 801, and may use the additional bit field information to, for example, access a server. In block 909, the mobile station may download a file, applet, application, or launch a previously stored application from applications 209 stored in mobile station memory 205.

In embodiments in which the mobile station interacts with the server, such as for example “Push-to-Pay” service, the mobile station transmits user selections to the server as shown in block 911. In block 913, the server performs a transaction and may additionally provide instructions to a kiosk via a network connection between the server and the kiosk. For example, the server may instruct the kiosk to provide a customer with a receipt of payment, or a paper magnetic strip card as might be the case in a “Push-to-Pay” parking facility kiosk. In block 915, the server completes the transaction and the kiosk may likewise perform a task such as printing out a receipt.

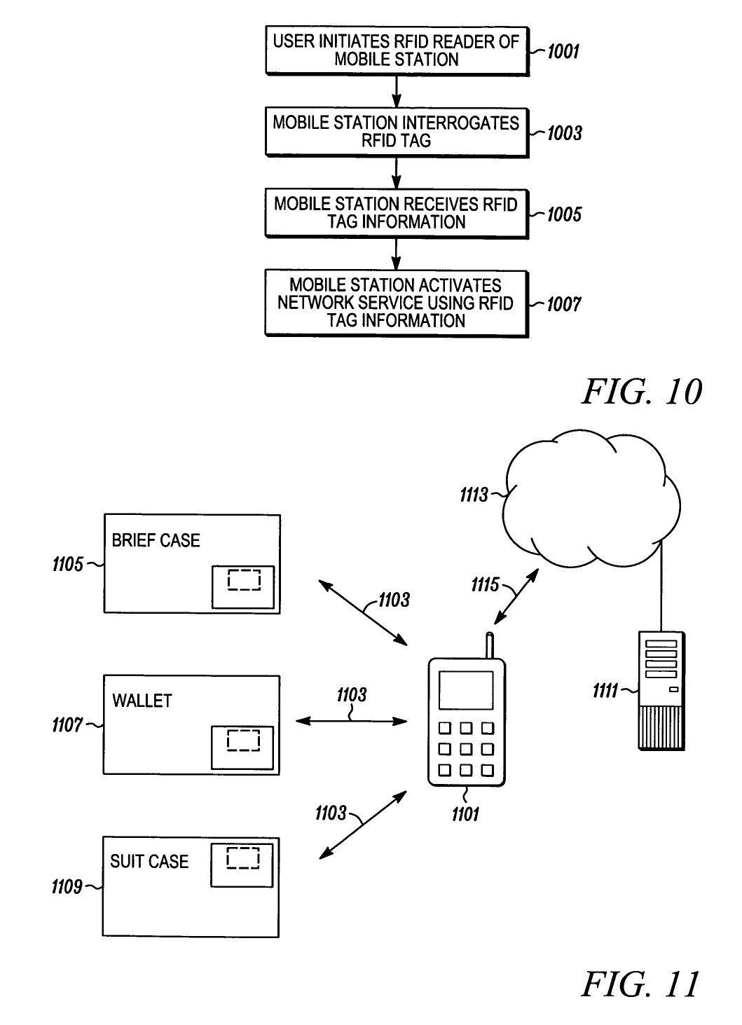

FIG. 10 is a flow diagram illustrating the basic operations of embodiments in which the RFID tag information 800 used to invoke action by the mobile station, or to invoke the mobile station to utilize a network service, such as call-forwarding. In block 1001, the user initiates the mobile station RFID interrogator 219 to make use of an RFID service similar to FIG. 9, block 901. In block 1003 the mobile station interrogates the RFID tag and receives the RFID tag information 800 as shown in block 1005.

The mobile station interprets the first bit field 801 and based on the category interpreted may invoke, for example call forwarding to forward future calls of the mobile station to a desk-phone as in a “Push-to-Forward” service. Another example, is “Push-to-Call” in which the mobile station may simply dial a phone number, or connect to an IP address, to place a telephone call using the mobile station service provider network such as WLAN AP 103 or WAN 107. An example of “Push-to-Call” may be a taxi service having a billboard with an RFID tag providing the automatic “Push-to-Call” taxi service.

It is to be understood that many services and business models are conceivable using the various embodiments of the present invention and that while several such embodiments have been disclosed herein, such embodiments are not a limitation on other similar embodiments that may be conceived that would remain in accordance with the present invention. For example, a “Push-to-Call” taxi service may be implemented by a mobile station application that generates an SMS message or email and transmits the message or email to a particular SMS or email address. For example, the mobile station application may generate a messages such as “Send taxi to 555 Water Street” using the location information contained in the tag. A taxi dispatch server may return a message to the mobile station for example, “Taxi will arrive at 555 Water Street in 5 minutes.”

FIG. 11 illustrates an embodiment of the present invention in which a mobile station may be used to implement a personal alarm system. In FIG. 11, mobile station 1101 comprises the components illustrated by FIG. 2 for mobile station 200, such that mobile station 1101 may interrogate and receive information from an RFID tag.

The mobile station 1101 may interrogate a set of RFID tags using air interface 1103. In FIG. 11, a set of personal items may have RFID tags, for example; a briefcase 1105, wallet 1107, suit case 1109, or other items. The mobile station 1101 may in some embodiments have a priori knowledge of the RFID information contained by a set of tags. In that case, mobile station 1101 may have the known RFID tag information stored in file storage 211 of memory 205. An alarm application residing in applications 209 will have a timing setting, which in some embodiments may be a user settable preference, such that the mobile station 1101 will perform an RFID interrogation automatically at set time intervals using RFID interrogator 219. The mobile station RFID interrogator 219 may use a singulation protocol so as to check each of the tagged items without encountering problems with conflicting tag responses. Alternatively, the mobile station 1101 may attempt to generally interrogate the tags and use a tree walking protocol to determine either the number of tags present or to determine the information from each item for comparison to the previously stored information.

If the alarm application determines that one of the tagged items is not present, the mobile station 1101 may provide an audible alarm to the user to indicate a possible loss or theft. In some embodiments the mobile station may automatically connect to a security system server 1111 and provide the server 1111 with the tag information of the missing item. If the mobile station user is within a building that has an appropriate RFID security system, which may be connected to an in-building network 1113, the building may have RFID interrogators posted at various strategic locations including but not limited to the building exits. In such embodiments, the mobile station 1101 may use network 1113 and wireless interface 1115 to inform the security server 1111 of a missing item. The RFID interrogation system may monitor for a tag having the noted information such that a potential thief may be intercepted prior to leaving an area.

One skilled in the art would recognize that systems in accordance with embodiments of the present invention could be beneficially used in airports, corporate campuses, university campuses, government buildings, etc. and could provide security for personal property as well as business, government or other property that is temporarily physically located within the confines of some definable geographic location.

Another application of the embodiment illustrated by FIG. 11 is a luggage locating capability. For example, in a crowded airport where a user is waiting for a luggage conveyer to dispense the user's particular items or item, such as suit case 1109, other travelers may have identical luggage pieces making finding suitcase 1109 a tedious task. By using an embodiment of the present invention, the user of mobile station 1101 may activate RFID interrogator 219 while in proximity of a familiar looking luggage item and determine whether it is in fact suit case 1109, by receiving an audible or visual indication from the mobile station 1101 display. Other applications in accordance with embodiments of the present invention are easily conceivable by one or ordinary skill in the art.

While the preferred embodiments of the invention have been illustrated and described, it is to be understood that the invention is not so limited. Numerous modifications, changes, variations, substitutions and equivalents will occur to those skilled in the art without departing from the spirit and scope of the present invention as defined by the appended claims.

What is claimed is:

1. A method of operating a mobile station comprising:
receiving data from a transponder;
parsing the data to obtain a service identifier and one of a telephone number and an Internet Protocol address; and
initiating a telephonic service corresponding to the service identifier using one of the telephone number and the Internet Protocol address.

2. The method of claim 1, wherein the telephonic service is one of; placing a telephone call to the telephone number, setting up call forwarding to the telephone number, and setting up a three-way call using the telephone number as one of the participants of the three-way call.

3. The method of claim 2 wherein the step of receiving data from the transponder further comprises:
decoding at least one bit field of the data to determine at least one decoded bit field information; and
comparing the at least one decoded bit field information to at least one pre-defined service identifiers in a memory of the mobile station.

4. The method of claim 3, wherein the at least one pre-defined service identifiers corresponds to at least one of; placing a telephone call to the telephone number, setting up call forwarding to the telephone number, and setting up a three-way call using the telephone number as one of the participants of the three-way call.

5. A mobile station comprising:
at least one wireless transceiver;
a transponder reader integrated with a data decoder;
at least one processor connected to the at least one wireless transceiver and to the transponder reader and configured to:
receive data from a transponder;
parse the data to obtain a service identifier and one of a telephone number and an Internet Protocol address; and
initiate a telephonic service corresponding to the service identifier using one of the telephone number and the Internet Protocol address.

6. The mobile station of claim 5, wherein the telephonic service is one of; placing a telephone call to the telephone number, setting up call forwarding to the telephone number, and setting up a three-way call using the telephone number as one of the participants of the three-way call.

7. The mobile station of claim 6 wherein the at least one processor is further configured to:
decode at least one bit field of the data to determine at least one decoded bit field information; and
compare the at least one decoded bit field information to at least one pre-defined service identifiers in a memory of the mobile station.

8. The mobile station of claim 7, wherein the at least one pre-defined service identifiers corresponds to at least one of; placing a telephone call to the telephone number, setting up call forwarding to the telephone number, and setting up a three-way call using the telephone number as one of the participants of the three-way call.
